(19) United States
(12) Patent Application Publication
(10) Pub. No.: US 2010/0129063 A1
(43) Pub. Date: May 27, 2010

(54) Recording Multimedia Data

(75) Inventor: Sin Woo Lee, Seoul (KR)

Correspondence Address: FISH & RICHARDSON, PC, P.O. BOX 1022, MINNEAPOLIS, MN, 55440-1022, US

(73) Assignee: CORE LOGIC, INC., Seoul (KR)

(21) Appl. No.: 12/626,555

(22) Filed: Nov. 25, 2009

(30) Foreign Application Priority Data
Nov. 26, 2008 (KR) 1020080118364

(51) Int. Cl. H04N 7/26

(52) U.S. Cl. 386/109; 386/E05.007

(57) ABSTRACT

According to the described techniques, apparatus and systems, a multimedia data processing device can include an input unit to receive media data from input devices. A data compression and information generating unit can compress the received media data and generate information based on the received media data. A buffer can temporarily store the compressed media data and generated information received from the data compression and information generating unit as a packet that includes a data packet and an information packet; output the temporarily stored media data packet and the information packet to be stored in an external storage device; and store a file offset that identifies a location of the information packet stored in the external storage device. A file format generating unit can generate a media data file format based on the information packet stored in the external storage device identified by the file offset stored in the buffer.

### CROSS-REFERENCE TO RELATED PATENT APPLICATION

This application claims the benefit of Korean Patent Application No. 10-2008-0118364, filed on Nov. 26, 2008, in the Korean Intellectual Property Office, the disclosure of which is incorporated herein in its entirety by reference.

### BACKGROUND OF THE INVENTION

The present disclosure relates to a multimedia system.

Generally, recording of multimedia data is typically needed in mobile communication terminals or camcorders, and is typically performed by encoding data output from image sensors such as cameras, or microphones and then storing the data in a predetermined file format. The file format used to store the data is typically selected according to whether the file format is standardized and is compatible with a player that is widely used, whether a compression format is supported for the file format, whether file storage and reproduction efficiencies are high when the file format is used, and whether a file recorded in the file format is easily compiled. An exemplary file format for third generation (3G) mobile communication terminals includes a moving picture experts group-4 (MPEG-4) (ISO/IEC 14496-12) file format (hereinafter, referred to as “MPEG-4”).

An MPEG-4 file is made of a number of object-oriented structures called atoms or boxes. In MPEG-4, media data and various pieces of information related thereto, i.e., media information, are typically stored in a moov: Movie box and a mdat: Media Data box, respectively. The media information may be obtained only through moov that is reference data stored in the moov: Movie box file. Due to the structural characteristics of MPEG-4, it may be impossible to sequentially store moov and mdat files in a disk when data is being recorded. In addition, because the size of various pieces of information to be stored in the moov file increases, it may be impossible to sequentially store all of the various pieces of information in a small capacity memory. Because sample tables (sample size, sample time, chunk offset, etc.), the reference information regarding each sample of the mdat file increase physically, it may be impossible to store information in a memory without limit.

Input media data is compressed by an encoder, and is stored in an mdat box of a disk. In addition, various pieces of information regarding the media data stored as the mdat file are stored as the sample table in a memory. When recording is finished, each sample table stored in the memory is stored in a moov format in a disk so as to complete the MPEG-4 file format. However, because each sample table stored in the memory increases in proportion to a recording time, memory consumption is increased, and therefore the recording time is limited according to the capacity of the memory. The recording time limitation may be significant in a mobile communication terminal in which memory capacity is limited.

### SUMMARY OF THE INVENTION

The techniques, apparatus and systems described in this disclosure can be implemented to provide a multimedia data processing device in which long-term recording may be performed by optimizing use of memory during the recording of multimedia in a multimedia system having limited memory capacity, such as a mobile communication terminal, a multimedia system including the multimedia data processing device, and a method of recording multimedia data.

In one aspect, a multimedia data processing device includes an input unit to receive media data from input devices. The multimedia data processing device includes a data compression and information generating unit to compress the received media data and generate information based on the received media data. The multimedia data processing device includes a buffer to temporarily store the compressed media data and the generated information received from the data compression and information generating unit as a packet. The packet includes a data packet and an information packet. The buffer outputs the temporarily stored media data packet and the information packet to be stored in an external storage device. The buffer stores a file offset that identifies a location of the information packet stored in the external storage device. The multimedia data processing device includes a file format generating unit to generate a media data file format based on the information packet stored in the external storage device identified by the file offset stored in the buffer.

Implementations can optionally include one or more of the following features. The buffer can include a data buffer to store the media packet; an information buffer to store the information packet; and a complex buffer to store the media packet stored in the data buffer together with the information packet stored in the information buffer, and output the media packet and the information packet to the external storage device.

The data buffer can include at least two buffers to perform double buffering of the media packet. The information buffer can include a first information buffer to store the information packet corresponding to the media data packet stored in the data buffer. The information buffer can include a second information buffer to store a copy of the information packet from the first information buffer when the first information buffer becomes full. The information packet in the first information buffer can be removed from the first information buffer after being copied and stored in the second information buffer. An information packet associated with new subsequent media data can be continuously stored in the first information buffer. When the second information buffer is full, the information packet stored in the second information buffer and the corresponding media packet stored in the data buffer can be copied and stored in the complex buffer. The media packet and the corresponding information packet stored in the complex buffer can be stored in the external storage device. The file offset identifying the location of the information packet stored in the external storage device can be stored in a predetermined portion of the buffer. Additionally, the file format generating unit can be configured to access the information packet from the external storage device identified by file offset; and generate a moov box associated with the accessed information packet in the external storage device. The accessed information packet can be temporarily stored in the buffer and used to generate the moov box. The file offset can be generated in the information packet and stored in the external storage device. When the information packet is a first information packet, a file offset associated with the first information packet can be stored in a predetermined portion of the external storage device; and when the information packet is an Nth information packet, a file offset associated with the Nth information packet can be stored in an (N−1)th information packet.

In another aspect, a multimedia system includes an input/output device to receive media data or send media data or both. The multimedia system includes a multimedia data processing device to generate information associated with the media data; temporarily store the media data and the generated information as a packet comprising a data packet and an information packet; output the temporarily stored media data packet and the information packet to an external storage device; store a file offset that identify a location of the information packet stored in the external storage device; and generate a media data file format based on the information packet stored in the disk identified by the file offset. The external storage device is configured to store the media data packet and the information packet processed by the multimedia data processing device. The multimedia system includes a host device in communication with the multimedia data processing device through an interface.

Implementations can optionally include one or more of the following features. The multimedia data processing device can include a buffer that includes a data buffer to temporarily store the media packet and an information buffer to temporarily store the information packet. The data buffer can include at least two buffers to double buffer the media packet. The file offset associated with the information packet stored in the external storage device can be stored in a predetermined portion of the buffer. The file offset can be generated in the information packet and stored in the external storage device. Additionally, when the information packet is a first information packet, a file offset associated with the first information packet can be stored in a predetermined portion of the external storage device. When the information packet is an Nth information packet, a file offset associated with the information packet can be stored in an (N−1)th information packet.

In another aspect, a method of recording multimedia data includes inputting media data received from one or more input devices. The method includes compressing the received media data and generating information associated with the received media data. The method includes storing the received media data and the generated information as a packet in a buffer. The packet stored in the buffer can include a data packet and an information packet. The method can include storing the packet in an external storage device and a file offset associated with the information packet of the packet in the buffer. The method can include generating a media data file format by using the information packet stored in the disk associated with the file offset. The buffer can include a data buffer to store the received media data as the media packet; an information buffer to store the generated information as the information packet in the information buffer; and a complex buffer to store the media packet stored in the data buffer together with the information packet stored in the information buffer. Storing the media data and the information as a packet in the buffer can include double buffering the media data using at least buffer in the data buffer. The information buffer can include first and second information buffers to store the information packet. The information packet associated with the media data stored in the data buffer can be stored in a first information buffer. When the first information buffer is full, the information packet can be copied and stored in the second information buffer, and then the information packet can be removed from the first information buffer to empty the first information buffer. An information packet associated with next media data stored in the data buffer can be continually stored in the emptied first information buffer. When the second information buffer is full, the information packet of the second information buffer and the media packet of the data buffer can be copied and stored in the complex buffer. Generating the media data file format can include accessing the information packet from the external storage device associated with the file offset; and generating a moov box in the external storage device. Storing the packet in the external storage device can include generating the file offset in the information packet.

When the information packet is a first information packet, a file offset associated with the first information packet can be stored in a predetermined portion of the external storage device. When the information packet is an Nth information packet, a file offset associated with the information packet can be stored in an (N−1)th information packet.

### BRIEF DESCRIPTION OF THE DRAWINGS

FIG. 1 is a structural view of a multimedia system according to an embodiment of the present invention;

FIG. 2 is a structural view of a buffer of FIG. 1, according to an embodiment of the present invention;

FIG. 3 is a conceptual view for explaining an operation of generating a moov box by using a buffer memory, according to an embodiment of the present invention;

FIG. 4 is a conceptual view for explaining a process of generating the moov box of FIG. 3, according to an embodiment of the present invention;

FIG. 5 is a structural view of an information packet generated by a multimedia data processing device, according to an embodiment of the present invention; and

FIG. 6 is a flow chart of a method of recording multimedia data, according to an embodiment of the present invention.

### DETAILED DESCRIPTION OF THE INVENTION

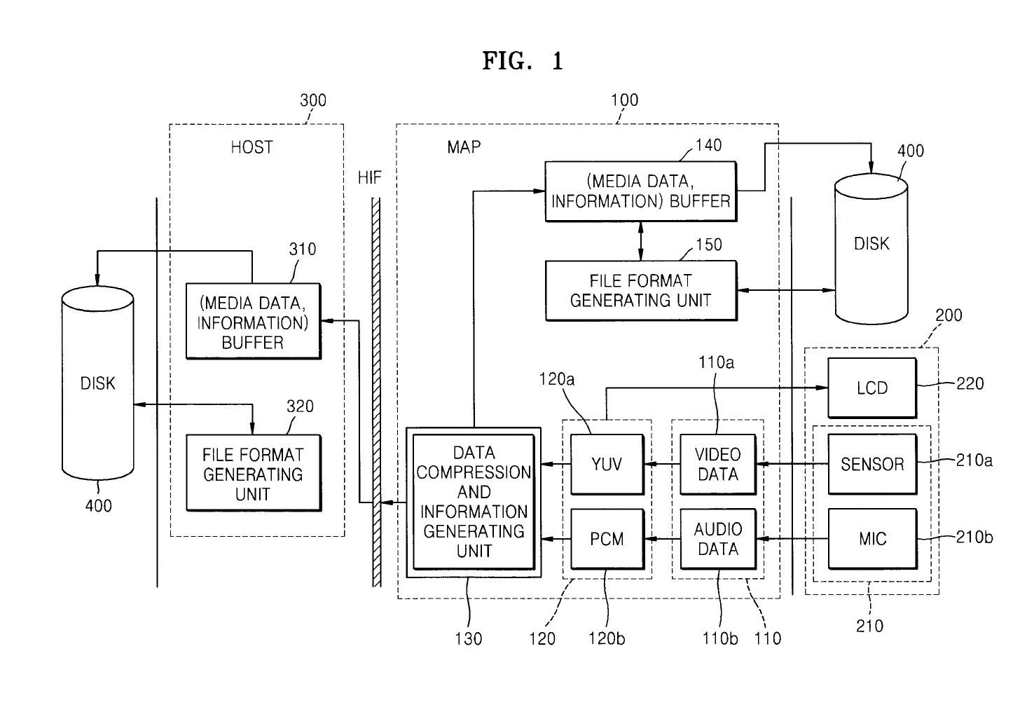

FIG. 1 is a structural view of a multimedia system according to an embodiment of the present disclosure.

Referring to FIG. 1, the multimedia system includes an input/output system 200, a multimedia data processing system 100, a storage system 400 and a host system 300.

The input/output system 200 may include an input device, an output device or both. The input device may include an image sensor device 210a, such as a digital camera to receive video data input, and a microphone 210b to receive audio data input. In addition, the output device may include a display device, such as a liquid crystal display (LCD) monitor 200. However, the input/output device 200 is not limited thereto, and thus the input/output device 200 may include different kinds of input devices to receive audio and video data input, and different kinds of output devices to present audio and video data output. The audio data and video data can be referred to as ‘media.’

The multimedia data processing system 100 can be implemented as one or more devices that include an input unit 110, a scaler unit 120, a data compression and information generating unit 130, a buffer 140 and a file format generating unit 150. The input unit 110 includes a video data input unit 110a and an audio data input unit 110b, and receives video data and audio data output from the input/output system 200. The video data is received at the video data input unit 110a, and the audio data is received at the audio data input unit 110b. The sizes of the video and audio data can be determined by a user. In addition, the video and audio data can represent raw data that is not processed.

The scaler unit 120 can include a video scaler 120a to scale the video data output received from the video data input unit 110a to a YUV frame, for example a YUV420 video frame or a YUV422 video frame. Also, the scaler unit 120 can include an audio data scaler 120b to scale the audio data output received from the audio data input unit 110b to an audio frame, such as a PCM audio frame. The data compression and information generating unit 130 can receive the scaled YUV video frame and PCM audio frame to compressed the data and generate information based on the video and audio data.

The data compression and information generating unit 130 can compress the video data and audio data output received from the scaler unit 120 by using a video encoder and an audio encoder, respectively. Also, the data compression and information generating unit 130 can generate information regarding the video data and the audio data, such as various pieces of sample data.

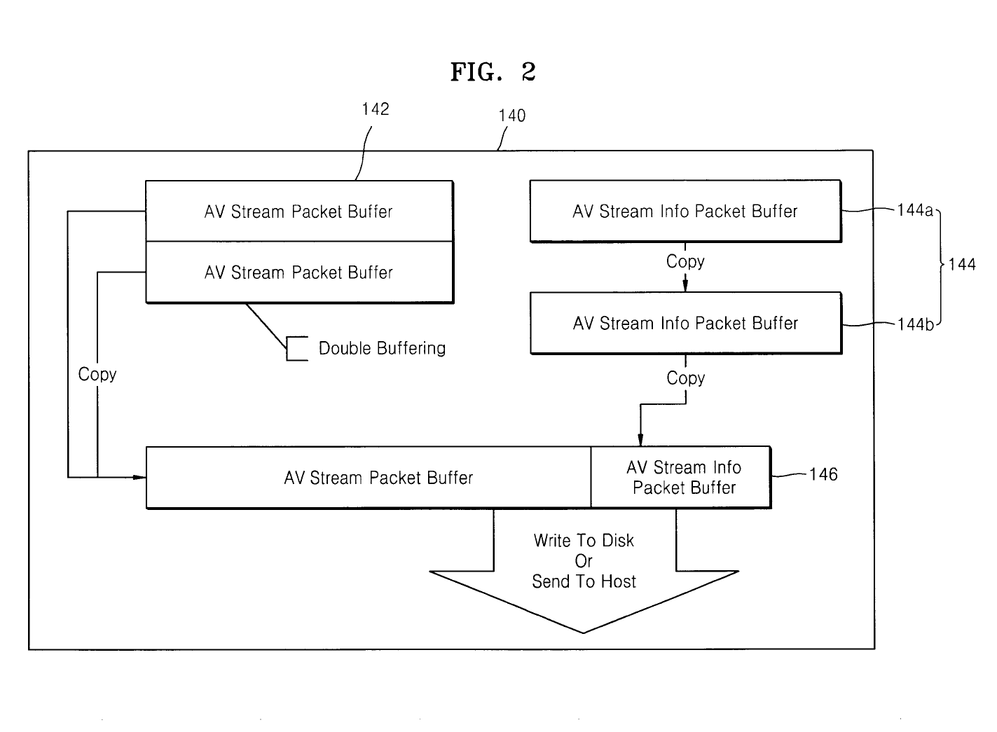

The compressed media data (e.g., video and audio data) and the generated pieces of information can be temporarily stored as a media packet and an information packet in the buffer 140, and the media packet and the information packet are then are stored in the storage system 400. The storage system 400 can include one or more volatile or non-volatile data storage devices, such as a disk, a hard drive, an optical disk, a flash memory, etc. The buffer 140 is described further, with reference to FIG. 2 below.

In general, the information packet can be continually stored in a memory of a buffer until memory capacity of the buffer is fully used. Implementations described in this specification can be used to copy a predetermined amount of the information packet and store the predetermined amount of the information packet in the storage system 400. The process of copying and storing the predetermined amount of the information packet can be repeated. Thus, the information packet can be stored in the storage system 400 having a large capacity rather than in the limited memory of the buffer 140.

To keep track of the information packet stored in the storage system 400, location information associated with each information packet, such as a file offset can be stored in a predetermined location of the buffer 140 whenever the information packet is stored in the storage system 400. For example, when a moov box is generated, the information packet stored in the storage system 400 is called and used, based on the file offset stored in the buffer 140. This process can be used to markedly reduce the capacity of a used memory when media data is recorded. For example, the information regarding media data of 1 minute duration can be replaced with a 4 byte file offset and stored in the buffer 140. In this manner, a 240 byte file offset may be sufficient for information regarding media data of 60 minutes.

Implementations described in this specification can be used to store the media information in the storage system 400, and a file offset associated with the media information is stored in the buffer 140. The media information of media data is not stored in the buffer 140. Thus, a smaller amount of memory is used when the media data is recorded by not having to record the media information in the buffer 140, In such manner, the media data may be recorded for a longer amount of time then when having to store the media information in the buffer 140.

Based on the file offset stored in the buffer 140, the file format generating unit 150 can generate a multimedia data file format by accessing the associated information packet stored in the storage system 400, and then generating the moov box in the storage system 400, as described above.

The host system 300 can control the multimedia system. The host system 300 can be in communication with the multimedia data processing system 100 or the input/output system 200 through a host interface (HIF). The host system 300 includes a buffer 310 and a file format generating unit 320. The host system 300 may receive media data and associated information from the data compression and information generating unit 130 of the multimedia data processing system 100, and may generate the multimedia data file format by using the storage system 400.

FIG. 2 is a structural view of the buffer 140 of FIG. 1, according to an embodiment of the present disclosure.

Referring to FIG. 2, the buffer 140 in the multimedia data processing system 100 can include a data buffer 142, an information buffer 144 and a complex buffer 146. A memory of a small size is generally used in the buffer 140.

The media data compressed in the data compression and information generating unit 130 is stored as a media packet in the data buffer 142. Information regarding the media data is stored as an information packet in the information buffer 144. The media packet of the data buffer 142 and the information packet of the information buffer 144 are combined and stored as a complex packet in the complex buffer 146. The complex packet may be stored in a disk such as an SD (Secure Digital) card, or may be transmitted to a host.

The data buffer 142 includes two buffers, and can perform double buffering. When one of the two buffers is full of data, the data is copied from this buffer and stored in the complex buffer 146, during which time the media data is continually stored in the other buffer. The information buffer 144 includes two buffers, such as a first information buffer 144a and a second information buffer 144b. When the first information buffer 144a is full of data, the data in the information buffer 144a is copied and stored into the second information buffer 144b. The first information buffer 144a is emptied after moving the data into the second information buffer 144b. Thus, the next data (e.g., information packet) generated, until the data buffer 142 is full, may be stored in the first information buffer 144a without losing the newly generated data. Then, when the second information buffer 144b is full of data, the data is moved to and stored in the complex buffer 146.

Thus, when the first information buffer 144a is full, the information packet stored in the first information buffer 144a is moved to and stored in the second information buffer 144b rather than being directly copied and stored in the complex buffer 146. Because the first information buffer 144a can move the stored information packet to the second information buffer 144b when full, the first information buffer 144a is again free to store the next media information that is generated, until the data buffer 142 is full, rather than being removed.

As a result, when information packets are accumulated so that the second information buffer 144b is flush with the packets, the media data of the data buffer 142 is copied and stored in the complex buffer 146. The second information buffer 144b can become flush with information packets by receiving the information packets from the first information buffer 144a. Additionally, in response to the media data of the data buffer 142 being copied and stored in the complex buffer 146, the data from the second information buffer 144b can be stored in the complex buffer. In some implementations, the data from the second information buffer and the media data from the data buffer can be stored in the complex buffer at the same time.

The media data stored in the complex buffer 146 can be stored in the storage system 400, as described above. When the media data from the complex buffer 146 is stored in the storage system 400, the location information associated with the information packet, such as a file offset, is stored in a predetermined portion of the buffer 140, and used to generate a moov box.

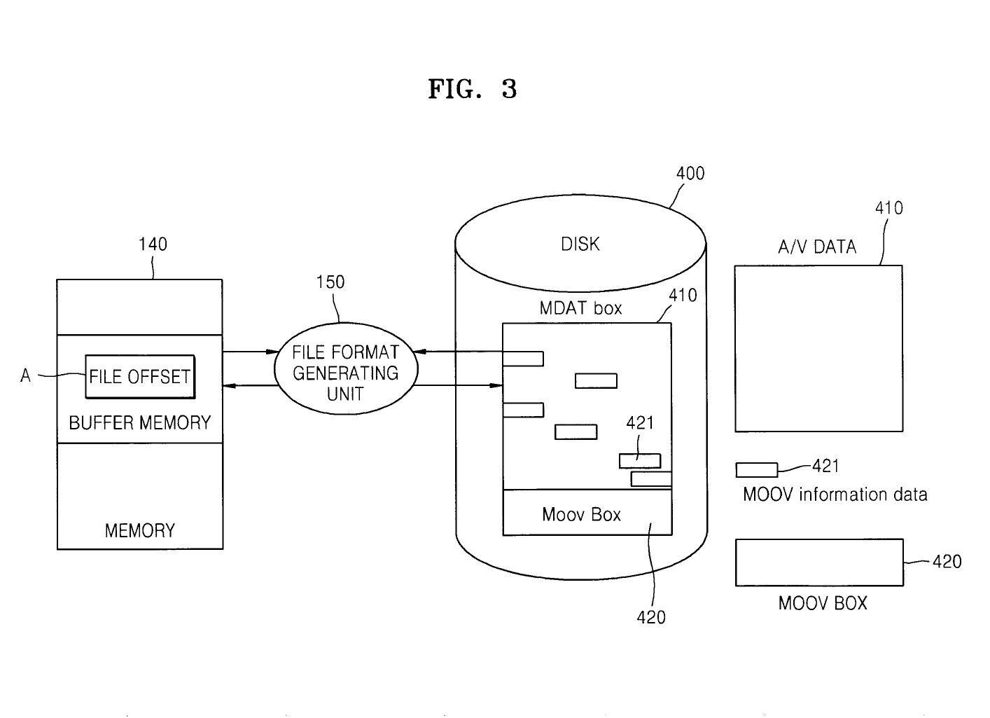

FIG. 3 is a conceptual view for explaining an operation of generating a moov box 420 by using a buffer memory, according to an embodiment of the present disclosure.

Referring to FIG. 3, compressed audio and video data, the A/V data or the media data, can be stored in an mdat box 410 of the storage system 400. Also, the information data for generating the moov box, such as an information packet 421, can be stored in the mdat box 410. The location information associated with the information packet 421, such as a file offset A, can be stored in the buffer 140.

When the media data is stored in the storage system 400, the file format generating unit 150 can complete a media data file format by accessing the information packet 421 from the mdat box 410 of the storage system 400, based on the file offset A stored in the buffer 140. This process temporarily stores the information packet 421 in the buffer 140, and moves and stores sample tables of the information packet into the moov box 420. Due to the large amount of information packets 421, the file format generating unit 150 may generate the moov box 420 by sequentially accessing multiple information packets, and sequentially storing sample tables corresponding to the accessed information packets in the moov box 420. In such manner, a single information packet can be accessed; a sample table corresponding to this single information packet can be stored in the moov box 420; and the accessed single information packet can be removed from the buffer 140. Then, another information packet can be called and stored in the moov box 420.

A sample table can contain various atoms or boxes that provide information about the physical location and timing of each sample. To maintain a compact table, the location and size information can be compacted by using a chunck (e.g., a run of contiguous samples). Also, sample-table-sample-to-chunk (STSC) values can be used to provide a mapping from sample number to chunk. The position of each chunk can be stored as a chunk offset measured from the beginning of the file that includes the chunk. A sample can be located using the sample-table-chunk-offset (STCO) value and the size of the preceding samples in the same chunk. For example, all video and audio samples can be treated as a single chunk, and the STCO value may be set for every sample. As a result, the STCO value may be set for every sample treated as a single chunk. In addition, although various samples can be treated as a single chunk, if the STCO value is set so that an information packet may not be inserted only in the middle of the chunk, no error occurs when media data is reproduced. Thus, even though an information packet, rather than a media packet (e.g., audio and video data), is stored in the moov box 420, an error can be avoided when reproducing the media data if an STCO value and an STSC value are set so that the information packet may not be located only in the middle of a chunk. If the information packet is located in the middle of the chunk, errors can be generated when the decoder decodes the packets. For example, the decoder may recognize the information packet as media data when found in the middle of the chunk.

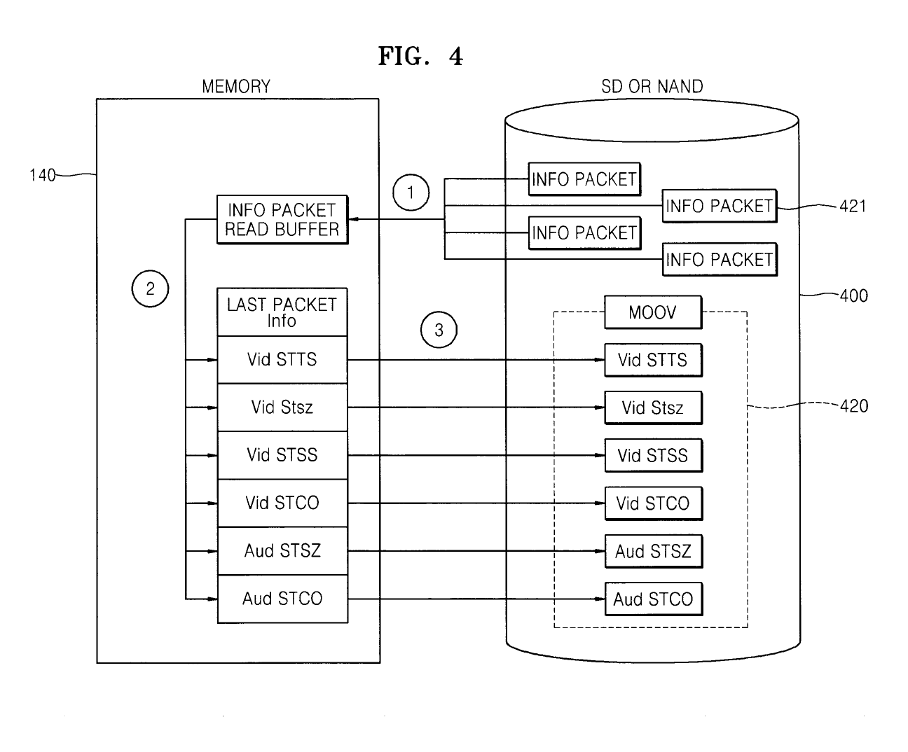

FIG. 4 is a conceptual view for explaining a process of generating the moov box 420 of FIG. 3, according to an embodiment of the present disclosure.

Referring to FIG. 4, the process of generating the moov box 420 is illustrated using arrows. Media packets and information packets, INFO PACKETS, regarding the media packets can be stored in a storage system 400, such as an SD or NAND storage device. The media packet and the information packets, INFO PACKETS, can be stored in the storage system through the buffer 140 when media data is recorded, as described with reference to FIG. 2.

As shown in operation (1), a file format generating unit (not shown) can call or transfer an information packet, INFO PACKET, from the storage system 400 into memory of the buffer 140, INFO PACKET READ BUFFER, based on the file offset of information packets stored in the buffer 140.

In operation (2), different information packets can be stored in the buffer 140. For example, FIG. 4 shows sample tables of information packets (e.g., LAST PACKET Info, Vid STTS, Vid Stsz, Vid STSS, Vid STCO, Aud STSZ and Aud STCO) that represent the different information packets stored in the buffer 140. The uppermost information packet, LAST PACKET INFO, is an example of a final information packet. While information packets are sequentially stored in or removed from the buffer 140, as described above, samples of the LAST PACKET INFO are stored in the moov box 420 of the storage system 400, and then the operation of generating the moov box 420 ends, which indicates that a multimedia file format is completed.

In operation (3), the sample tables of the information packets stored in the buffer 140 are stored in the moov box 420 of the storage system 400 using the file format generating unit.

By generating the moov box 420 through the above described process, a multimedia data processing device as described this specification can record multimedia data for a longer period of time than possible in the conventional device. Recording multimedia data for longer period of time is possible because when media data is stored in the storage system 400, the information packets related to the media data are stored in the storage system 400, which has a large capacity than the buffer 140 memory. Moreover, a file offset of the information packet, rather than the media data, is stored in the memory (e.g., buffer 140). Thus, when recording of the media data is finished, the file format generating unit may generate the moov box 420 by calling the information packets stored in the storage system 400, based on the file offset stored in the memory, the buffer 140.

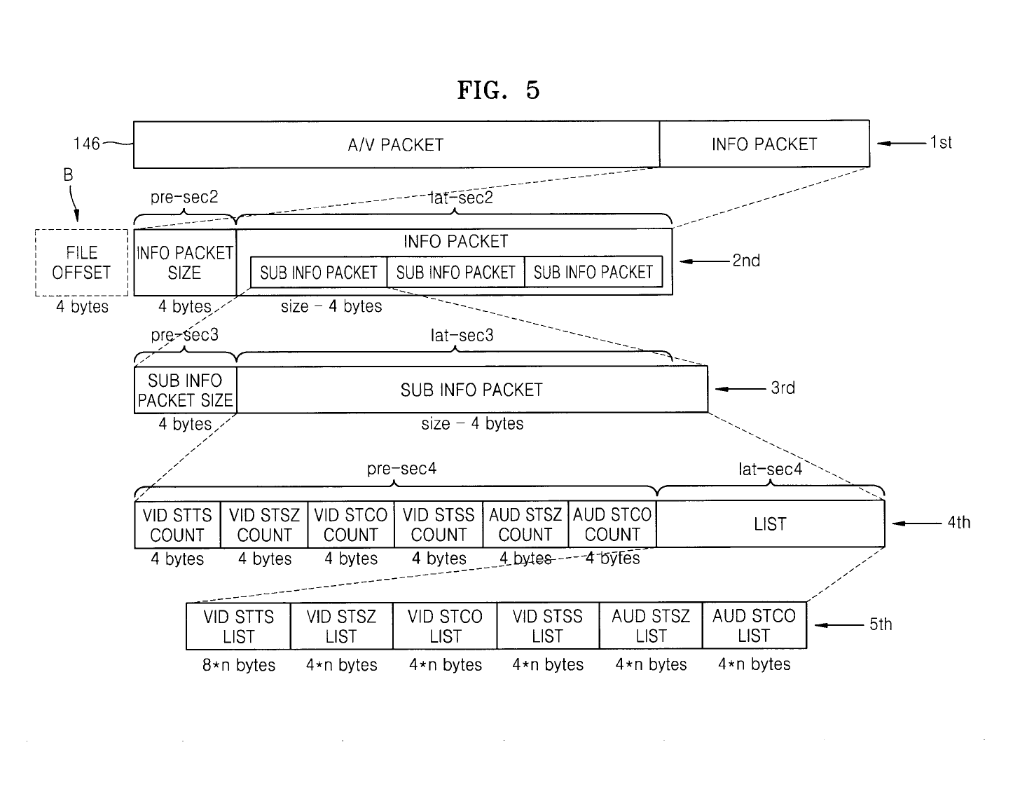

FIG. 5 is a structural view of an information packet generated by a multimedia data processing device. Referring to FIG. 5, a media packet, A/V PACKET, which is related to the audio and video data, and an information packet, INFO PACKET, are stored in the complex buffer 146. The media packet, A/V PACKET, has no predetermined format. The information packet, INFO PACKET, has a predetermined form, and information regarding the audio and video data may be stored in the information packet, INFO PACKET. The information packet, INFO PACKET, may have a form in which about 4 bytes of size information regarding a latter sector, lat-sec2, is stored in a previous sector, pre-sec2, and material information is stored in the latter sector, lat-sec2.

For example, in a second structure, 2^{nd}, the size information regarding the information packet, INFO PACKET, is stored in the previous sector, pre-sec2, and multiple pieces of information data including multiple sub information packets, SUB

INFO PACKETS, are stored in the latter sector, lat-sec2. In addition, with regard to each sub information packet, SUB INFO PACKET, the size information regarding the sub information packet, SUB INFO PACKET, is stored in a previous sector, pre-sec3, and material information data is stored in a latter sector, lat-sec3, like in a third structure, 3rd. In FIG. 5, ‘VID’ refers to video, “AUD” refers to audio, “STTS” refers to a sample table time stamp, “STSZ” refers to a sample table size, “STCO” refers to a sample table chunk offset, and “STSS” refers to a sample table sync sample. Also, counts of STTS, STSZ, STCO and STSS contained in the respective latter sectors, lat-sec4, are stored in previous sectors, pre-sec4. The counts indicate the numbers of STTS, STSZ, STCO and STSS, and the size of each count is 4 bytes.

The media packet AN PACKET and information packet INFO PACKET stored in the complex buffer 146 in this structure are moved to a disk (e.g., the storage system 400) and stored therein. As described above, the media packet, AN PACKET, and information packet, INFO PACKET, may be called again based on a file offset associated with the information packet, INFO PACKET, stored in the buffer 140. However, when a device is powered-off (by removing the batteries, for example) during a photographing operation, the information stored in a memory is permanently lost.

Thus, it may be meaningless to store a file offset associated with the information packet, INFO PACKET, in the buffer 140. As a result, the information packet, INFO PACKET, stored in the disk may not be found, and thus a moov box may not be generated.

To overcome such data loss, sectors in which a file offset is stored may be generated in the information packet, INFO PACKET. As illustrated in FIG. 5, 4 bytes of a file offset sector are formed prior to a size sector of the information packet, INFO PACKET, and a file offset is stored in the file offset sector. The file offset is not related to its information packet, but is related to a next information packet. That is, if the current information packet is a (N−1)^{th} information packet, the location information regarding a N^{th} information packet, a file offset, is stored in a file offset sector of the

(N−1)^{th} information packet. Thus, when a previous information packet is found, an information packet subsequent to the previous information packet may be also found. An initial information packet may be stored in an appropriate location of a mdat box. For example, the size and type of data to be stored are stored in a start portion of the mdat box. 4 bytes of file offset regarding the initial information packet may be stored in a portion just behind the start portion of the mdat box.

By storing the file offset associated with a subsequent information packet in a previous information packet, and storing a file offset associated with an initial information packet in a mdat box of a disk, a moov box may be generated with reference to the file offset even though the device is powered-off (e.g., by extracting the battery).

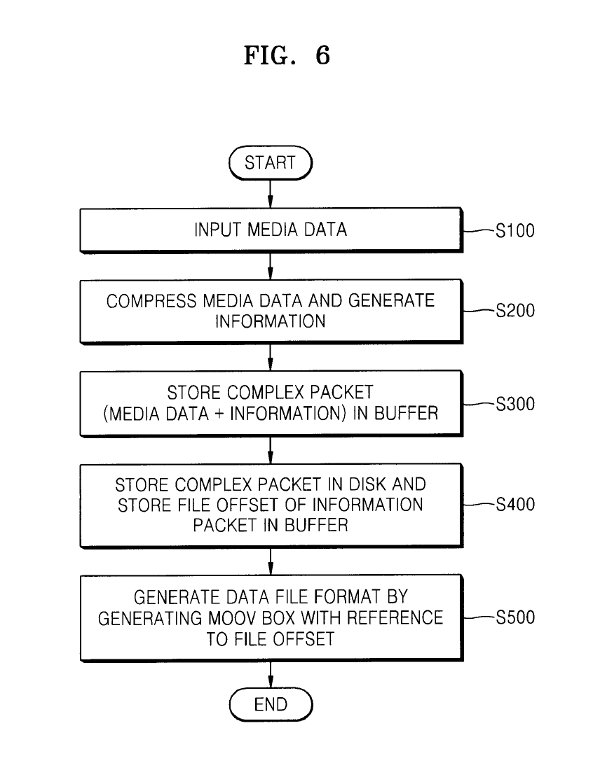

FIG. 6 is a flow chart of a method of recording multimedia data, according to an embodiment of the present invention.

Referring to FIG. 6, media data, the audio data and video data output from external input devices is received or inputted (operation S100). The received audio and video data are compressed, and information associated with the audio and video data is generated (operation S200). The audio and video data can optionally be scaled by a scaler prior to compressing the audio and video data.

Double buffering is performed on the compressed media data by a buffer, the compressed media data is stored as a media packet in a complex buffer, and the information associated with the stored media data is stored as an information packet in the complex buffer (operation S300). The media packet and the information packet can be combined as a complex packet and stored in the complex buffer. The process of storing the complex packet in the complex buffer is described above with reference to FIG. 2.

The complex packet stored in the complex buffer is stored in a disk (e.g., a storage system 400), and a file offset associated with the information packet is stored in a memory, the buffer (operation S400). When recording of the media data is finished, a file format generating unit completes a media data file format by generating a moov box with reference to the file offset stored in the buffer (operation S500). The process of generating the moov box is described above with reference to FIGS. 3 and 4.

According to the embodiments described here, when a media data packet and an information packet are stored in a disk, the amount of memory used can be markedly reduced by maintaining a file offset associated with the information packet in a memory buffer and generating a moov box with reference to the file offset. By reducing the memory usage, a longer-term recording of multimedia data can be achieved.

In addition, in the multimedia data processing device described here, the file offset is generated in the information packet, the information packet is stored in a disk, and the information packet is found with reference to the file offset. Thus, even when the multimedia data processing device is powered-off or the batter extracted, a moov box may be easily generated.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Only a few implementations and examples are described and other implementations, enhancements and variations can be made based on what is described and illustrated in this application.

What is claimed is:

1. A multimedia data processing device comprising:
an input unit to receive media data from input devices;
a data compression and information generating unit to compress the received media data and generate information based on the received media data;
a buffer to
temporarily store the compressed media data and the generated information received from the data compression and information generating unit as a packet comprising a data packet and an information packet,
output the temporarily stored media data packet and the information packet to be stored in an external storage device, and
store a file offset that identifies a location of the information packet stored in the external storage device; and
a file format generating unit to generate a media data file format based on the information packet stored in the external storage device identified by the file offset stored in the buffer.

2. The multimedia data processing device of claim 1, wherein the buffer comprises:
a data buffer to store the media packet;
an information buffer to store the information packet; and
a complex buffer to
store the media packet stored in the data buffer together with the information packet stored in the information buffer, and
output the media packet and the information packet to the external storage device.

3. The multimedia data processing device of claim 2, wherein the data buffer comprises at least two buffers to perform double buffering of the media packet.

4. The multimedia data processing device of claim 2, wherein the information buffer comprises:
a first information buffer to store the information packet corresponding to the media data packet stored in the data buffer; and
a second information buffer to store a copy of the information packet from the first information buffer when the first information buffer becomes full, wherein the information packet in the first information buffer is removed from the first information buffer after being copied and stored in the second information buffer; and
wherein an information packet associated with new subsequent media data is continually stored in the first information buffer.

5. The multimedia data processing device of claim 4, wherein, when the second information buffer is full, the information packet stored in the second information buffer and the corresponding media packet stored in the data buffer are copied and stored in the complex buffer.

6. The multimedia data processing device of claim 2, wherein the media packet and the corresponding information packet stored in the complex buffer are stored in the external storage device; and
wherein the file offset identifying the location of the information packet stored in the external storage device is stored in a predetermined portion of the buffer.

7. The multimedia data processing device of claim 1, wherein the file format generating unit is configured to
access the information packet from the external storage device identified by file offset; and
generate a moov box associated with the accessed information packet in the external storage device.

8. The multimedia data processing device of claim 7, wherein the accessed information packet is temporarily stored in the buffer and used to generate the moov box.

9. The multimedia data processing device of claim 1, wherein the file offset is generated in the information packet and stored in the external storage device.

10. The multimedia data processing device of claim 9, wherein, when the information packet is a first information packet, a file offset associated with the first information packet is stored in a predetermined portion of the external storage device; and
wherein, when the information packet is an N^{th} information packet, a file offset associated with the N^{th} information packet is stored in an (N−1)^{th} information packet.

11. A multimedia system comprising:
an input/output device to receive media data or send media data or both;
a multimedia data processing device to
generate information associated with the media data,
temporarily store the media data and the generated information as a packet comprising a data packet and an information packet,
output the temporarily stored media data packet and the information packet to an external storage device,
store a file offset that identify a location of the information packet stored in the external storage device, and
generate a media data file format based on the information packet stored in the disk identified by the file offset;
the external storage device is configured to store the media data packet and the information packet processed by the multimedia data processing device; and
a host device in communication with the multimedia data processing device through an interface.

12. The multimedia system of claim 11, wherein the multimedia data processing device comprises a buffer comprising a data buffer to temporarily store the media packet and an information buffer to temporarily store the information packet,
wherein the data buffer comprises at least two buffers to double buffer the media packet, and
wherein the file offset associated with the information packet stored in the external storage device is stored in a predetermined portion of the buffer.

13. The multimedia system of claim 11, wherein the file offset is generated in the information packet and stored in the external storage device, and when the information packet is a first information packet, a file offset associated with the first information packet is stored in a predetermined portion of the external storage device, and
wherein, when the information packet is an N^{th} information packet, a file offset associated with the information packet is stored in an (N−1)^{th} information packet.

14. A method of recording multimedia data, the method comprising:
inputting media data received from one or more input devices;
compressing the received media data and generating information associated with the received media data;
storing the received media data and the generated information as a packet in a buffer, wherein the packet stored in the buffer comprises a data packet and an information packet;
storing the packet in an external storage device and a file offset associated with the information packet of the packet in the buffer; and
generating a media data file format by using the information packet stored in the disk associated with the file offset.

15. The method of claim 14, wherein the buffer comprises:
a data buffer to store the received media data as the media packet;
an information buffer to store the generated information as the information packet in the information buffer; and
a complex buffer to store the media packet stored in the data buffer together with the information packet stored in the information buffer.

16. The method of claim 15, wherein, storing the media data and the information as a packet in the buffer comprises double buffering the media data using at least buffer in the data buffer; and
wherein the information buffer comprises first and second information buffers to store the information packet.

17. The method of claim 15, wherein the information packet associated with the media data stored in the data buffer is stored in a first information buffer, and when the first information buffer is full, the information packet is copied and stored in the second information buffer, and then the information packet is removed from the first information buffer to empty the first information buffer; and
wherein an information packet associated with next media data stored in the data buffer is continually stored in the emptied first information buffer.

18. The method of claim 15, wherein when the second information buffer is full, copying the information packet of the second information buffer and the media packet of the data buffer and storing the copied information packet buffer and the media packet in the complex buffer.

19. The method of claim 14, wherein generating the media data file format comprises:
accessing the information packet from the external storage device associated with the file offset; and
generating a moov box in the external storage device.

20. The method of claim 14, wherein storing the packet in the external storage device comprises generating the file offset in the information packet.

21. The method of claim 19, wherein when the information packet is a first information packet, storing a file offset associated with the first information packet in a predetermined portion of the external storage device; and
when the information packet is an N^{th} information packet, storing a file offset associated with the information packet in an (N−1)^{th} information packet.
